(19) United States
(12) Patent Application Publication
(10) Pub. No.: US 2008/0215466 A1
(43) Pub. Date: Sep. 4, 2008

(54) METHODS AND APPARATUS FOR MAKING AND KEEPING RECORDS

(76) Inventor: ROBERT E. ELBRADER, Louisburg, KS (US)

Correspondence Address: NOBLITT & GILMORE, LLC., 4800 NORTH SCOTTSDALE ROAD, SUITE 6000, SCOTTSDALE, AZ, 85251, US

(21) Appl. No.: 12/119,772

(22) Filed: May 13, 2008

Related U.S. Application Data
(63) Continuation of application No. 10/339,993, filed on Jan. 10, 2003.

(51) Int. Cl. G06Q 10/00

(52) U.S. Cl. 705/30

(57) ABSTRACT

A recordkeeping system according to various aspects of the present invention includes a recording system and an activation system. The recording system is configured to create a record of a deal session when activated. The activation system is connected to the recording system, and is configured to automatically activate the recording system upon initiation of the deal session and deactivate the recording system upon termination of the deal session. In one embodiment, the recording system includes one or more cameras and a network video recorder, and the activation system comprises a computer terminal. The computer terminal and one of the cameras are co-located. When the user initiates a deal on the computer system, the computer system may automatically activate the camera to record the deal session. When the deal is terminated, the computer may deactivate the camera, and the resulting video record may be stored.

### FIELD OF THE INVENTION

The invention relates to methods and apparatus for making and keeping records.

### BACKGROUND OF THE INVENTION

Many federal and state consumer protection laws and regulations affect the typical merchant, especially those offering expensive items like automobiles, homes, boats, heavy equipment, or potentially hazardous situations, such as surgical procedures or sky diving. The number of laws and regulations, such as in finance and insurance of automobiles, make it more difficult to ensure that a deal is properly performed and documented and potentially expose the companies to liability. More laws, regulations, and documents create more opportunities for errors and misrepresentation. Similar problems may be confronted in other fields, such as home purchasing and finance, providing insurance, and financial services.

Consequently, many companies invest heavily in training personnel in compliance with the laws and regulation and expend great effort to monitor the activities of their personnel. Unfortunately, training demonstrates limited effectiveness and monitoring personnel presents significant problems. For example, monitoring systems balance acquisition of necessary information against being excessive intrusion and nuisance. In addition, monitoring systems tend to be cumbersome. Additional steps in the deal process hinder productivity, occupy valuable space, inconvenience the personnel and the customer, and may be avoided by the personnel. Further, without some system for recording interactions between the parties, the memories of the parties may differ as to an agreement or a discussion, potentially causing conflict.

### SUMMARY OF THE INVENTION

A recordkeeping system according to various aspects of the present invention includes a recording system and an activation system. The recording system is configured to create a record of a deal session when activated. The activation system is connected to the recording system, and is configured to automatically initiate activation of the recording system upon initiation of the deal session and deactivate the recording system upon termination of the deal session. In one embodiment, the recording system includes one or more cameras and a network video recorder, and the activation system comprises a computer terminal. The computer terminal and one of the cameras are co-located. When the user initiates a deal on the computer system, the computer system may automatically activate the camera to record the deal session. When the deal is terminated, the computer may deactivate the camera, and the resulting video record may be stored. The stored record may be accessed, either locally or remotely, for later use.

### BRIEF DESCRIPTION OF THE DRAWINGS

A more complete understanding of the present invention may be derived by referring to the detailed description when considered in connection with the following illustrative figures. In the following figures, like reference numbers refer to similar elements and steps.

FIG. 1 is a block diagram of a recordkeeping system according to various aspects of the present invention;

FIG. 2 is a diagram of a recordkeeping system having a record system including cameras and an NVAR;

FIG. 3 is a block diagram of a control system having an activation system and an administrative system;

FIGS. 4A-B are a flow diagram of a deal session process using a recording system; and

FIG. 5 is a flow diagram for remotely accessing the recordkeeping system.

Elements and steps in the figures are illustrated for simplicity and clarity and have not necessarily been rendered according to any particular sequence. For example, steps that may be performed concurrently or in different order are illustrated in the figures to help to improve understanding of embodiments of the present invention.

### DETAILED DESCRIPTION OF EXEMPLARY EMBODIMENTS

The present invention is described partly in terms of functional components and various steps. Such functional components and processes may be realized by any number of components configured to perform the specified functions and achieve the various results. For example, the present invention may employ various elements, materials, recording devices, activation systems, audio/visual recording systems, storage systems, databases, and the like, which may carry out a variety of functions. In addition, the present invention may be practiced in conjunction with any number of applications, environments, networks, and type of transactions, and the systems described are merely exemplary applications for the invention. Further, the present invention may employ any number of conventional techniques for manufacturing, assembling, mounting, operation, and the like.

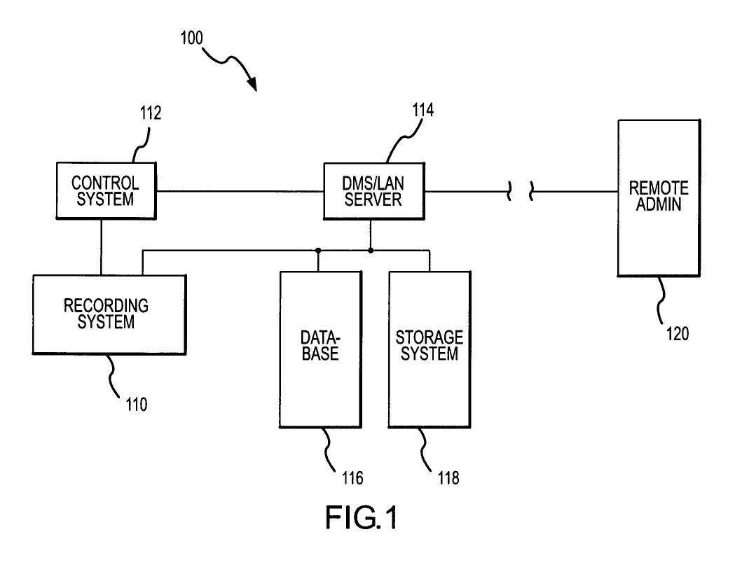

A recordkeeping system according to various aspects of the present invention makes records of activities or interactions for monitoring or review. The recordkeeping system may be configured to generate any suitable record for any transaction or purpose. In the present embodiment, the recordkeeping system is configured to make a record for a transaction relating to a new or used automobile purchase, such as a record of interactions between a producer (i.e., a salesperson or other representative of a company) and a customer for the purpose of purchasing an automobile. In particular, referring to FIG. 1, a recordkeeping system 100 according to various aspects of the present invention may be configured to make, store, and index an audio and/or visual record of a finance and insurance (F&I) transaction.

The recordkeeping system 100 may, however, be configured for any appropriate purpose or environment, such as for deal records in other fields, for example automobile purchasing or leasing, real estate purchasing, lending, or leasing, insurance purchases, or other fields requiring disclosures or advisories provided to the customer. Various environments for which the recordkeeping system may be adapted include purchases of furniture, office equipment, construction equipment, such as heavy construction equipment or trucks, and recreational vehicles, like boats, airplanes, trucks, RVs, and motorcycles. The recordkeeping system 100 may also be adapted for medical procedures, such as surgical notes during surgery, medical discussions with patients, and dental situations. Similarly, the recordkeeping system may be adapted for financial matters, such as banking or investment advising. The recordkeeping system 100 may also be configured for additional or alternative uses to make records for various purposes, such as to make a record of real-life examples of customer interaction sessions or create feedback records for training or evaluation purposes. The recordkeeping system 100 may also provide or be integrated into other systems, for example a security system that makes security records using cameras for monitoring purposes or a publicly-accessible “web cam” connected to the Internet to display activities at the location.

The recordkeeping system 100 for making records according to various aspects of the present invention may be implemented in conjunction with a recording system 110 and a control system 112. The recording system 110 records an event to create a record. The control system 112 controls operation of the recordkeeping system 100, such as activating the recording system 110 to record the event. For example, in one embodiment, the recording system 110 is configured to record communications relating to a transaction. The control system 112 is configured to activate the recording system 110 to record the session relating to the transaction, as well as store, index, and access the record.

The recording system 110 creates the record of the transaction. The recording system 110 may comprise any suitable system for making relevant records, such as an audio, video, and/or data recording system. In the present embodiment, the recording system 110 comprises a recording device and a data receiver. The recording device converts information into signals and the data receiver receives and stores the signals from the recording device.

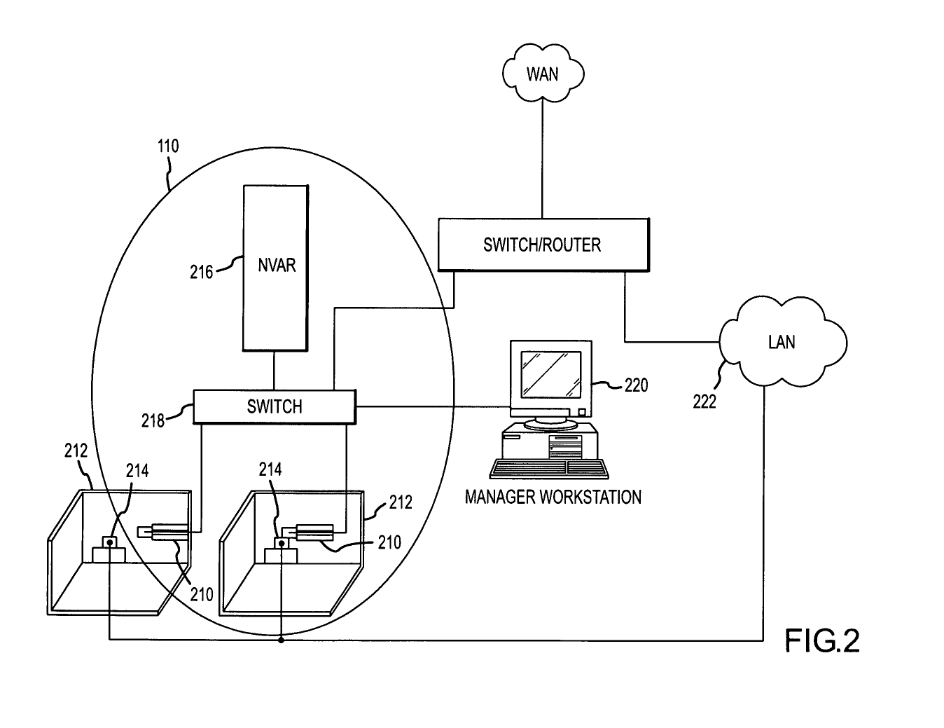

The recording device may comprise any suitable system for transferring information to the data receiver, such as a camera having a microphone for making a visual and audio record of the transaction. For example, referring to FIG. 2, the recording system 110 suitably comprises multiple video-audio cameras 210. The recording device may, however, comprise any suitable information gathering devices, such as microphones, computer terminal monitoring systems such as keystroke monitoring devices or other systems for monitoring computer use, video cameras without audio connections, computer logs, and telephone recorders.

Each camera 210 may be dedicated to a particular site, such as a particular office, desk, angle, or person, and each camera 210 is individually controllable. In the present embodiment, each camera 210 is dedicated to a particular office 212 having a computer terminal 214 where information relating to the transaction is entered. The location and the configuration of the recording device, however, may be adjusted according to the particular environment or use of the recordkeeping system 100.

The data receiver is configured to receive information, such as video and audio data, from the recording devices for storage. The data receiver may comprise any appropriate system for receiving data from the recording devices and storing the data, such as a videocassette recorder, an analog video recorder, a digital video recorder, a CD burner, a DVD burner, or any other system for recording data received from the recording devices. In the present embodiment, the data receiver comprises a network video-audio recorder (NVAR) 216 configured to receive data from the one or more of the recording devices via a network. The NVAR 216 is suitably configured to store the data from the recording devices. The NVAR 216 may also be configured to include long-term storage for the data and perform other data management functions, such as indexing records and archiving or purging out-of-date records.

In the present embodiment, the NVAR 216 is configured to receive control signals from the control system 112 and control the cameras 210 accordingly. In addition, each camera 210 and NVAR 216 may be associated with a unique internet protocol (IP) address for addressing the camera 210. In the present system, all communications with the cameras 210 are sent via the NVAR 216. Any appropriate connection technique and/or system, however, may be employed to facilitate operation of and communication with the cameras 210 and NVAR 216.

The data receiver may also include a backup data receiver. For example, the recording system 110 may include multiple NVARs 216. If one NVAR 216 is not functioning properly, the recording system 110 may be configured to try a second NVAR 216 and provide the signal from the recording device to the second NVAR 216.

The recording devices may be connected to the data receiver in any suitable manner to transfer the data to the data receiver. For example, the recording devices may transfer information to the data receiver via direct connections, wireless communications, a router, a server, a large network such as a wide area network (WAN), shared communication lines such as telephone lines, a telephone connection, a global network like the Internet, and the like. In the present embodiment, the cameras 210 and the NVAR 216 are connected to a local area network (LAN), such as a wireless LAN, via a switch 218. The switch 218 provides one main connection point for the recording system 110 to other components of the recordkeeping system 100. The switch 218 also provides isolation of the recording system 110 from other components of the network, such as a LAN server, and facilitates communications between the NVAR 216, the cameras 210, and other components of the recordkeeping system 100.

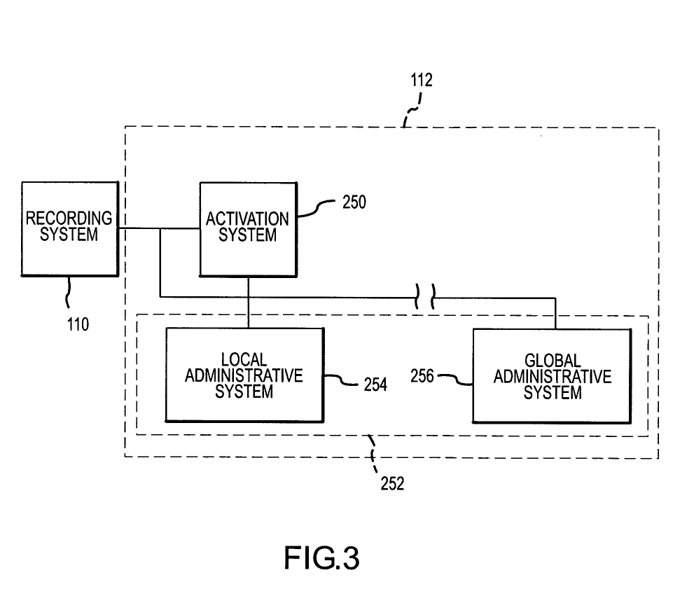

The recordkeeping system 100 may also include the control system 112 for controlling the recording devices and/or receiving information from the recording devices, storing and indexing the records, accessing the records, and management of the recordkeeping system 100. The control system 112 may comprise any suitable system for controlling the recording devices, such as activating and deactivating the recording devices, checking the recording devices' status, setting up the recording devices, monitoring a particular transaction as it occurs, and/or receiving diagnostic information. Referring to FIG. 3, in the present embodiment, the control system 112 comprises an activation system 250 and an administrative system 252. The activation system 250 controls the activation and deactivation of the recording system 110 during a deal session. The administrative system 252 controls the overall operation of the recordkeeping system 100, including the recording system 110.

The activation system 250 may comprise any suitable system for activating and deactivating the recording device at a desired time or upon a particular event. The activation system 250 may be a manual and/or automatic system. For example, the activation system 250 may comprise a dedicated power switch for activating the recording device, or may be connected to another system, such as a timer, motion sensor, light switch, voice detection or recognition system, and the like. In a transaction-related system, the activation system 250 is suitably associated with an event that signals the beginning and the end of the transaction, such as voice activation, closing of an office door, or toggling a light switch.

The present activation system 250 is configured to prompt the user to select whether to activate the camera 210 when the user requests to enter information relating to an F&I deal. The rules and procedures for activation, deactivation, and denial of activation and deactivation, however, may be selected according to any suitable criteria. For example, in the present embodiment, the activation system 250 is associated with the computer terminals 214 located in the offices 212 in which the cameras 210 are located.

The computer terminals 214 may comprise any suitable computer terminals, such as personal computers, dumb terminals connected to a mainframe or other central computer system, or standalone computers. The cameras 210 may be linked to the computer terminals 214 in any appropriate manner to activate the relevant camera 210 upon initiation of a deal session in the office 212 having the camera 210. The computer terminal 214 of the present embodiment is connected to the camera 210 via a LAN 222 and a LAN server 114, though the computer terminal 214 and the camera 210 may be connected in any suitable manner to cause the camera 210 to respond to the computer terminal 214. Each computer terminal 214 is associated with a particular camera 210. The camera 210 may be dedicated to the computer terminal 214, or more than one computer terminal may be associated with one camera 210, or more than one camera 210 may be associated with one computer terminal 214.

The computer terminals 214 are suitably configured to activate and deactivate the corresponding cameras 210. In the present embodiment, the activation and deactivation of the cameras 210 is integrated into a program for entering a deal into the computer system, such as any suitable business management software. In the present embodiment, the program suitably comprises an F&I data entry application operating on a dealership's dealer management system (DMS) or other similar system. The F&I application comprises a suitable system for entering information relating to a transaction into the DMS or other relevant database or computer system. The activation and deactivation process, however, may be implemented in any suitable manner, such as in conjunction with a separate program or a different program.

The administrative system 252 facilitates control of the recordkeeping system 100, including the recording system 110, a database 116, a storage system 118, and a retrieval system. The administrative system 252 may comprise any suitable system for interacting with the other components. For example, the administrative system 252 suitably includes a software system operating on a computer, such as the dealership's DMS server and/or a LAN server 114, for setting up the recordkeeping system 100, establishing access rules, storage rules, and purging rules, generating database structures, monitoring system operation, monitoring transactions, and other functions. The administrative system 252, however, may be configured in any suitable manner to control the recordkeeping system 100.

The administrative system 252 is suitably separated into multiple levels and users are suitably assigned one or more authorization levels. In the present system, the administrative system 252 includes a global administrative component and a local administrative component. The local administrative component is configured to provide control functions for a single operation or small group of operations, such as a car dealership or group of dealerships, and the global administrative component provides control functions for an umbrella organization, such as a headquarters operation working with multiple different car dealerships. The administrative system 252 of the present embodiment comprises two components, though any suitable control hierarchy may be used.

In addition, the administrative authority may be further divided, for example among administrative fields, using authorization levels. In the present embodiment, accounting staff may have an authorization level granting access to various transactional data functions, but may be denied access to initiating F&I transactions; conversely, a producer (a salesperson or other representative) authorization level may initiate F&I transactions, but may be denied access to transactional data for other producers or accounting information. Computer personnel and managers may have authorization levels granting greater access to all functions.

In the present embodiment, the local administrative system 254 may comprise local administrative software operating on the local DMS/LAN server 114. The DMS/LAN server 114 or other system operating the local administrative system 254 is suitably connected to the other local components of the recordkeeping system 100, for example via the LAN. The local administrative system 254 suitably controls the recordkeeping system 100 for local operations, such as those associated with a particular store or dealership. For example, the local administrative system 254 may facilitate control of the local recording system 110, including maintaining user identification information, facilitating searching of the database 116, performing local diagnostics and maintenance of the system, checking the status of the recording system 110, remote real-time monitoring of ongoing deal sessions, providing access to and managing the purging of locally created records, and the like.

The local administrative system 254 may also provide for camera control for the local cameras, such as camera 210 and NVAR 216 status checks, camera 210 pan/tilt/zoom, camera 210 two-way audio control, NVAR 216 control, camera 216 control, and matrix control. The local administrative system 254 may operate in conjunction with or separately from other systems, such as the DMS, and may operate on the same or different computers.

Similarly, the global administrative system 256 suitably comprises global administrative software operating on a remote system 120. The remote system 120 suitably communicates with and is connected to the other components of the recordkeeping system 100, for example via a WAN or a global network like the Internet. Any suitable communications system, however, may be employed to connect the various components of the recordkeeping system 100, including intermittent or continuous telephonic connections, wireless networks, communication relays, global networks, or other appropriate systems.

The global administrative system 256 suitably controls the recordkeeping system 100 for more than one local operation, such as an entire corporate operation or a particular region having multiple dealerships. For example, the global administrative system 256 may allow creation and integration of the local administrative system 254, facilitate control of the database 116 and storage system 118, and may select records for retention, disposal, or transfer to another site, such as a storage location associated with the company headquarters.

The global administrative system 256 may also provide various capabilities similar to the local administrative system 254. For example, the global administrative system 256 may facilitate searching of the database 116, checking the status of recording systems 110 at various locations, remote real-time monitoring of ongoing deal sessions, including providing camera control for local cameras 210 in a particular room in a particular dealership, or reviewing of records maintained in the storage system 118 or in the NVARs 216.

The recordkeeping system 100 may be managed on the local level or the global level. Access to the recordkeeping system 100 by the local administrative system 254 may be provided in any suitable manner, such as by directly accessing the control system 112 via the DMS/LAN server 114. For managing or monitoring system remotely, access is suitably provided through Internet access or other remote connection. In addition, any suitable interface may be provided to remote access to the recordkeeping system 100

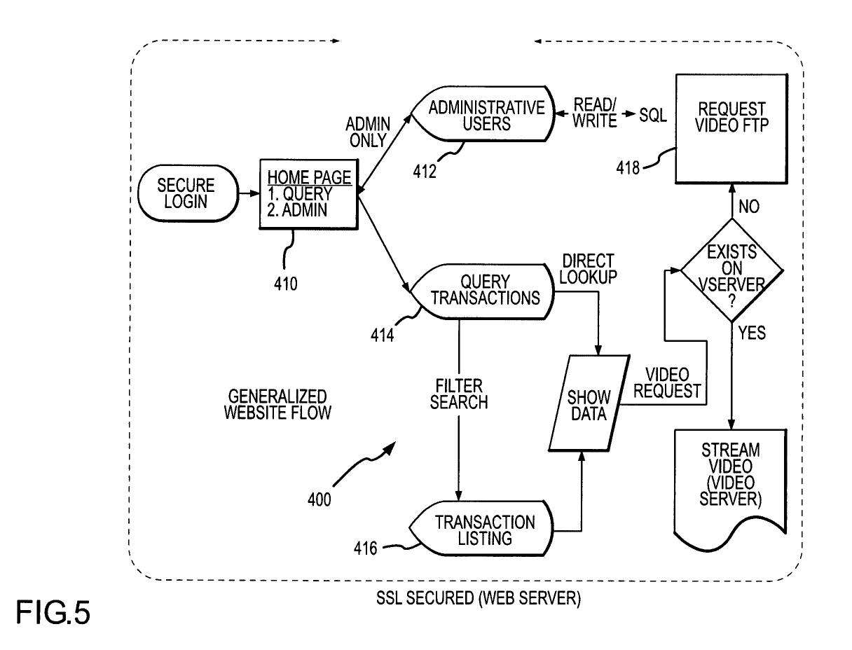

In the present embodiment, remote access is provided through a remote access process. The remote access process may be implemented in any suitable manner, such as in conjunction with conventional software, like a web browser. Referring to FIG. 5, in a remote access process 400 according to various aspects of the present invention, the user accesses the control system 112 using an Internet browser to display a particular website homepage. The control system 112 may “browser sniff” to determine the user's browser. At the opening screen, the user provides a username and password (410). The site may also invoke security systems, such as a secure socket layer process.

The control system 112 checks for the validity of the username and password and determines the user's access level. If the user has administrative access (412), the user may perform various administrative functions, such as changing user information or the configuration of the control system 112. For nonadministrative users, upon login and gaining access, the user may gain access to various functions, such as accessing a transaction (414), searching for a transaction (416), requesting a record from the archive (418), or viewing a record (420). If the user has appropriate authorization, the user may also select a particular dealership and camera and activate the camera 210 and/or monitor the current session.

The control system 112 may also be configured to generate reports according to any appropriate criteria. The reports may provide data that may be useful in evaluating and/or improving operations. For example, the control system 112 may be configured to search a number of deals executed by the individual producers at a dealership and a number of deals in which each producer elected to deactivate the camera 210. The control system may be configured to calculate a ratio of the two numbers, and identify those producers for whom the ratio exceeds a particular threshold. Based on the report, the manager may wish to explore further to determine why the camera is being turned off by those producers more often than their colleagues. Any appropriate reports or figures, however, may be analyzed.

The control system 112 may also include dedicated systems for performing various tasks or providing various features. For example, a control system 112 according to various aspects of the present invention includes a dedicated manager workstation 220 configured specifically for the operation manager. For example, the manager workstation 220 may be configured to permit direct access to the cameras 210 to monitor transactions in the offices 212, as well as activate various cameras 210 the manager's direction. The manager workstation 220 may also have access to the NVAR 216 to quickly replay any record stored in the NVAR 216. The manager workstation 220 may be otherwise configured to provide the manager with any desired operations or abilities.

The recordkeeping system 100 may also include the storage system 118 for storing records. The storage system 118 may comprise any suitable system for storing the records, and may be adapted to the type of records made and the other components of the recordkeeping system 100. For example, the storage system 118 may comprise a hard drive array, multiple DVD media stored in a DVD changer for automatic access, a tape drive system, an array of videotapes, or any other storage system for storing the records. The storage system 118 may be located at any suitable location, such as in the same facility as a local server, at a remote storage location, or a central storage location associated with multiple facilities.

The storage system 118 suitably comprises a mass data storage system. The mass data storage system may comprise any suitable system for storing records, such as a hard drive array. Furthermore, the storage system 118 and its operation may be adapted according to the operation of the recordkeeping system 100. For example, the storage system 118 may comprise a large but relatively slow archive system for long-term storage of records. Thus, the storage system 118 may maintain more records and/or retain records for a longer duration, such as for multiple recording systems 110.

In the present embodiment, the storage system 118 includes the NVAR 216 and a centralized storage facility for storing records received from multiple car dealerships. Short-term storage is provided locally, such as using the NVAR 216. At various times, such as at regular periods or when the NVAR 216 is approaching a threshold amount of data, records may be purged from the NVAR 216 or transferred to the storage system 118. When a record is transferred, for example via file transfer protocol or other suitable method, to the storage system 118, an entry is suitably provided to the database 116 so that the record may be located.

If desired, the recordkeeping system 100 may be configured such that only records specified for transfer to the storage system 118 are retained. A record may be specified for transfer for any appropriate criteria, such as regular sampling, relevance to a particular issue, producer, customer, or dealership, or other reason. All other records are removed from the recording system, for example using an internal expiration process, on a rotating basis, or according to any other suitable purging process. For example, purging can be done based on a fixed period, according to a disk space threshold, or manually. Specific information relating to the record, however, such as the record metadata, may be retained.

The recordkeeping system also suitably includes a database 116 for storing transaction summaries (instead of records themselves) and information relating to the recordkeeping system 100 and facilitating retrieval of data and records. The database 116 may comprise any suitable system for maintaining and organizing the relevant information, such as a conventional SQL database. Further, the database 116 may store and organize any desired information, such as transaction summaries, record tracking information, and user information. The database 116 may be a local database for a location, such as a particular dealership, or larger database, such as for a larger organization or a region, or may be configured as a distributed or shared database at multiple locations. The database may also be a dedicated database for the recordkeeping system 100, or may be updated by, shared with, or integrated into the database of another system, such as the DMS.

The database may contain any suitable information relating to the transaction and/or the record. For example, in the present system, the database includes fields for store name, deal number, creation date and time, customer name, user identification and name, deal access reason code and description, camera status, camera start and end time and date, location in which the record was made, NVAR address for NVAR 216 that made the record, lender identification, product purchased, and other details of the transaction or other suitable information. The various fields facilitate searching to identify a particular transaction and/or record. The fields may also include one or more fields for identifying a storage location of the record. Alternatively, the storage location of the record may be stored in a different database that may be searched using deal numbers or any other appropriate information or criteria.

In the present embodiment, the database 116 stores user information and transaction information. The user information may be stored in any appropriate manner, such as in an SQL table, and may include information like first and last names, username, password, dealership ID, telephone number, e-mail address, active/inactive status, and user authorization level. The user information may also include a camera rights field, such as to designate users that are not allowed to bypass the recording system 110 or users that are never required to use the recording system 110.

The database 116 may also be configured for periodic import/export of user files to and from the DMS/LAN server 114, for example to synchronize the users of the DMS system to those of the recordkeeping system 100. The username and password may be identical to other systems, such as the DMS system, to provide easier use by the user. In addition, user information may be shared among various systems, such as the DMS, the recordkeeping system 100, an e-mail system, a payroll system, and the like.

The database 116 may also store information relating to transactions and the associated records. The database 116 may comprise any suitable system for maintaining information relating to the records and the transactions, and may be adapted to the type of records made, the other components of the recordkeeping system 100, and the relevant transactions.

For example, the database 116 may comprise a conventional computer-driven database providing rapid search and retrieval of information. In the present embodiment, the database 116 comprises an SQL database for storing transaction summaries. Further, the database may include copies of the transaction documents themselves, for example in PDF format, or storage information for locating electronic and/or physical copies of the transaction documents.

The transaction summaries have multiple fields to facilitate searching and correlation of information. For example, a representative set of fields for storage in the database relating to a particular transaction may include the transaction number, the date of the transaction, the name of the producer handling the transaction, the name of the buyer, and, among other items, the record identifiers and storage locations for all records associated with the transaction made by the recording system 110.

The retrieval system facilitates retrieval of records for viewing or other treatment. The retrieval system may be configured in any suitable manner to find and retrieve records, including a conventional database search engine, one or more lookup tables, a directory associated with transactions, and the like. In addition, the retrieval system may be implemented in any suitable manner, such as a software system operating in the global administrative system 256 and/or the local administrative system 254.

In operation, the local administrative system 254 is provided with information relating to the various users having access to the recordkeeping system 110, fir example by importing information from the DMS. The user information may comprise any appropriate information for any purpose, for example to ensure security, provide contact information, track user status, assign authorization levels, and establish camera rights. In the present embodiment, the user information includes first and last names, username, password, dealership ID, telephone number, e-mail address, active/inactive status, and user authorization level. The user information may also include a camera rights field for identifying users that are not allowed to bypass recording, are not prompted for recording, or treated normally.

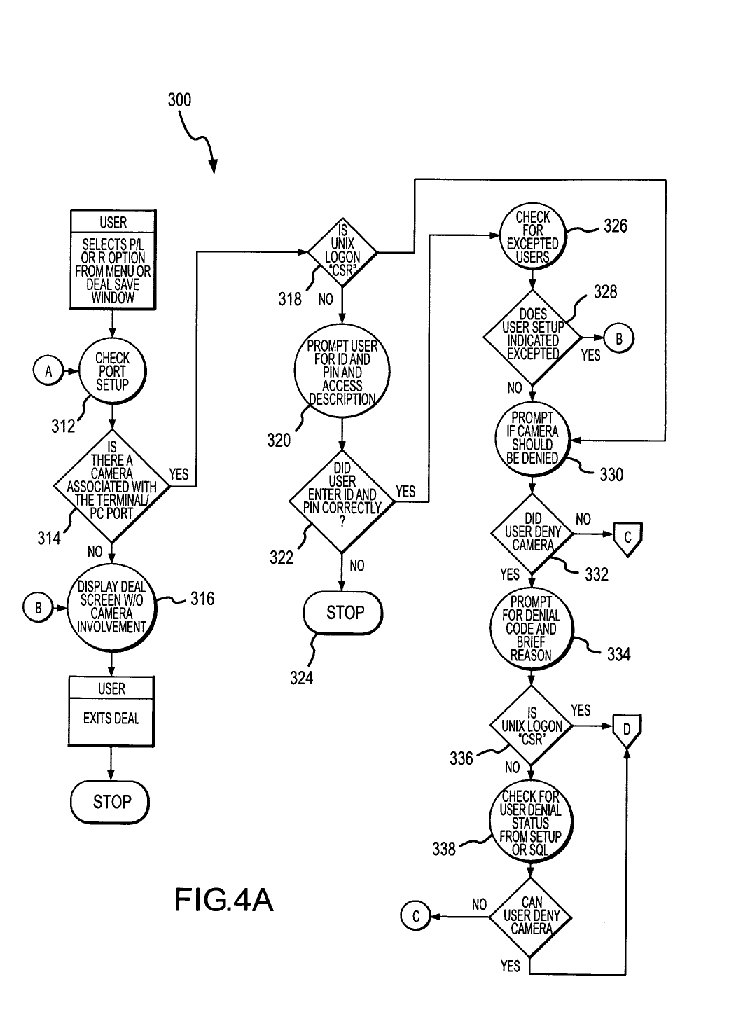

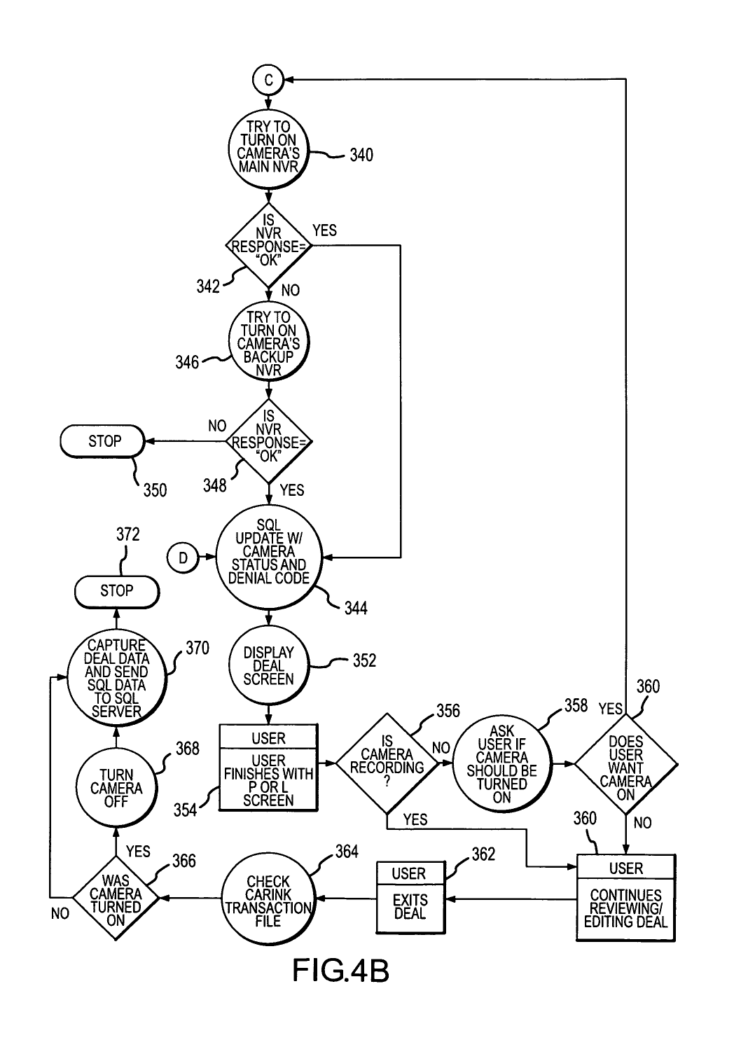

The recordkeeping system 100 is suitably configured to activate the relevant recording device and receiving device at a desired time or upon occurrence of a trigger event. In the present embodiment, the trigger event is a juncture in the business management software, such as the access of a deal summary screen in the DMS system, or any other event that signifies the initiation of activity that requires disclosure of information or is otherwise subject to regulation. For example, referring to FIGS. 4A-B, to perform a transaction, the producer enters an office 212 with the customer to enter, revise, or update information in the DMS system relating to a transaction. When the computer terminal 214 is activated, the producer selects a task from a number of possible options. For example, the producer may choose to start a new application, open a contacts database, or enter information relating to a deal using the DMS system, such as a new purchase deal, a new lease deal, or a new custom lease deal, or recall a deal (310). If the producer elects to enter information for a deal or recall a deal, the control system 112 initiates a deal session 300 process to process the transaction.

The deal session process 300 checks a port setup for the particular terminal (312) to determine whether a camera is associated with the relevant office, terminal, or other location. If no camera is associated with the location, or if the relevant camera is not available due to maintenance or malfunction (314), then the relevant deal screen is displayed and the producer proceeds with the transaction (316). Alternatively, the recordkeeping system 100 may be configured to prohibit the entry of the transaction and require the producer to move to a location having an available camera. The deal session process 300 may include a notation in the database indicating that no video record was made of the transaction, which may include the reason for the failure to record the deal session.

If a camera is available, the deal session process 300 determines whether the user login information identifies the user as a customer service representative (CSR) (318). If so, a user identification process may be skipped. If the logon is not CSR, however, then the deal session process 300 prompts the producer to enter identification information, which suitably includes a secure identifier, such as a password or personal identification number (320). If the identification information is invalid (322), the producer is denied access and the deal session process may terminate (324). To determine whether the identification information is valid, the identification information may be compared to several sources. For example, the identification information may be compared to information for local personnel and information for headquarters personnel. Thus, local personnel may gain access at their particular location, but headquarters personnel may gain access from any terminal connected to the recordkeeping system 100, for example via the Internet.

If the identification information is valid, the deal session process 300 suitably determines the user's status (326). If the user is classified as EXCEPTED (328), such as for management personnel, the camera 210 may remain deactivated, the relevant deal screen is displayed, and the user may proceed. The activation system 250 may also send a message, such as a set of deal meta data, to the database 116 when the deal screen is initiated to record the activity on the transaction. Upon saving and exiting the deal, the deal session process 300 may include a notation in the database indicating that no video record was made of the deal session due to the user's EXCEPTED status.

If the user is not an EXCEPTED user, the deal session process suitably prompts the user to select whether to activate the camera 210 (330). If the user agrees to activate the camera 210 (332), the deal session process proceeds to activate the camera 210. If the user elects to leave the camera 210 deactivated, the user is prompted for a reason for the deactivation election (334). For example, the deal session process 300 may provide multiple reasons from which to choose. The user may also be allowed or required to enter a comment to support the election to forego activation of the camera 210.

After providing the reason, the user's camera status is determined. If the user logon is CSR (336), the election to deactivate is accepted and the deal session process 300 proceeds. If the user logon is not CSR and the user has FULL RECORD status (338), the deal session process proceeds to activate the camera 210, regardless of the user's election to forego activation. If desired, the deal session process may provide a notice to the user that the camera 210 has been activated despite the election to not activate it.

In an alternative embodiment, the camera is activated according to the status of the transaction. For example, if the producer is accessing a transaction that is designated as PENDING, meaning that the transaction has not yet reached the CONTRACTING stage, the camera 210 remains deactivated. If the transaction has progressed to be designated as CONTRACTING or RECONTRACTING, indicating that the documentation for the transaction is being prepared and reviewed, the camera is activated, regardless of the producer's request. Any suitable classification of the transaction status or other selection system may be used to determine whether and when to activate or deactivate the camera 210.

To activate the camera 210, the activation system 250 suitably provides an activation signal to the recording system 110 (340). If the recording system 110 receives the signal and is operating properly (342), the recording system 110 responds with an OK signal and the deal session process 300 proceeds with updating the database regarding the camera 210 status and, if relevant, the reason for camera deactivation (or attempted camera deactivation) (344). If the recording system does not provide an OK signal, the activation system 250 may attempt to turn on a backup recording system (346). If the backup system does not function (348), the deal session process 300 may terminate (350). Otherwise, the camera 210 activates and the deal session process 300 proceeds with updating the database 116 regarding the camera 210 status and, if relevant, the reason for camera deactivation (or attempted camera deactivation).

The deal session process 300 may then display the relevant screen for entry of the transaction data while the camera 210 is operating (352). Upon partial completion, such as upon a request to save or exit the transaction screen (354), the deal session process 300 determines whether the camera 210 is activated (356). If the camera 210 is not on, the user may be prompted to elect whether to activate the camera 210 while reviewing and/or editing the entries in the DMS system 114 (358). If the user elects to turn on the camera (360), the deal session process 300 executes the camera 210 activation process. If not, or if the camera is already activated, the producer may proceed with reviewing and editing the computer entries (360).

When the user completes entering, editing, or reviewing the information (362), the DMS system 114 suitably determines whether the transaction data is complete (364). Next, if the camera 210 was activated (366), it is deactivated (368), and the transaction information is stored (370). Further, the database is suitably updated to include the new information, and the deal session process 300 terminates (372).

After creation, the records may be stored at any suitable location and according to any appropriate process or system. For example, records may be stored locally, such as in the NVAR 216, for a selected time period after making the record. The record may then be moved to the storage system 118 for longer storage. To facilitate efficient storage, the record may be compressed or otherwise processed to reduce the storage requirements of the record. The record may also be purged after a selected time or according to any other suitable criteria.

In the present embodiment, the data is initially retained in the NVAR 216. The corresponding transaction information in the database 116 is adjusted to indicate that the record is stored at the local NVAR 216 at a particular location. Upon request, or at a selected time, such as at the end of the day or week or when the NVAR 216 is nearly full of data, or according to any other appropriate criteria, the record may moved to the storage system 118. By waiting until the end of the week or end of the day, the records may be transferred at a time when data traffic is relatively low and network resources are more likely to be available. When the record is moved to the storage system 118, the database 116 may be updated to indicate the current storage location of the record.

The record may be retained in the storage system 118 for any duration or according to any suitable criteria. In the present embodiment, the records are only stored in the NVAR 216 and are purged after a selected period, unless the record is otherwise designated for transfer to the storage system 118. For example, if the record is particularly relevant to an ongoing issue or provides a good example of how to perform a transaction, a manager or trainer may wish to retain, move, or copy the record to the storage system 118. If the record is not otherwise designated, the record may be purged or moved to offline storage, such as onto a DVD or a data tape.

In the present embodiment, the retrieval system retrieves records by identifying a storage location for the record and requesting the record from the storage location. For example, to find a particular record, the user may log onto the recordkeeping system 100. Upon acquiring access, the user may initiate a search for the record using any suitable search criteria to search the database 116. For example, the user may enter a customer name and receive a list of transactions relating to customers having the name.

The retrieval system initially searches the database 116 for the transaction summary. For example, the database 116 may be accessed using direct queries and search queries. For direct queries, the user provides specific information to identify a transaction, such as a transaction number, a customer phone number, or customer social security number. If more than one transaction record fits the direct query criteria, the query may be treated as a search query and multiple results may be provided from which the user may select. For search queries, the database 116 may be searched according to any suitable search criteria, such as by filtering or browsing by date range, loan administrators, customer last names, and the like. The search results are suitably provided as a list.

The database 116 may be accessed in any suitable manner to identify desired information. The user may then select and review a transaction summary to confirm that the selected transaction is the desired transaction. If so, the user may review information relating to the record from the transaction summary. For example, the record information may include a record identifier and when the record was made and the location. The record information may also include status information, such as the current storage location of the record. If the record has been purged, the record information may note that the record was purged, but retain the other data, such as the time and place the record was made.

When the desired record is selected, the results suitably provide a link or other identifier corresponding to the record to facilitate retrieval, if the record exists, is accessible, has not been purged, and is otherwise available. The user may then initiate retrieval of the corresponding record. For example, the user may provide the record location and identifier to the retrieval system, such as by selecting a link from a computer interface or copying the record identifier and storage location information into a computerized record request screen.

The record storage information suitably provides a storage location for the record, for example in the storage system 118 or an NVAR 216. The retrieval system is suitably configured to send a request to the database 116, storage system 118, or NVAR 216 or other storage facility to determine whether the record is available. If the record is available, the record may be provided to the user in any suitable manner, such as via streaming or file transfer. If the record is not available, the server may request a search for the record. If the record is found within a selected time period, the video may be stored at an accessible location and the user notified.

Thus, a recordkeeping system according to various aspects of the present invention facilitates making a record, such as an audiovisual record, of a transaction. The record may be stored for access at a later time, for example in the event of a dispute or other issue. The recording system is configured to be automatically activated to create a relevant record, such as upon initiation of the deal session, and deactivated upon termination of the deal session. The records may then be stored and accessed using the control system, either locally or remotely.

The particular implementations shown and described are illustrative of the invention and its best mode and are not intended to otherwise limit the scope of the present invention in any way. Indeed, for the sake of brevity, conventional manufacturing, connection, preparation, and other functional aspects of the system may not be described in detail. Furthermore, the connecting lines shown in the various figures are intended to represent exemplary functional relationships and/or physical couplings between the various elements. Many alternative or additional functional relationships or physical connections may be present in a practical system.

The present invention has been described above with reference to a preferred embodiment. However, changes and modifications may be made to the preferred embodiment without departing from the scope of the present invention. These and other changes or modifications are intended to be included within the scope of the present invention.

1-30. (canceled)

31. A recordkeeping system for making records of an automobile purchase, comprising:
a recording system adapted to record a meeting; and
a computer coupled to the recording system and adapted to execute a program, wherein:
the program includes a finance portion adapted to facilitate entry of data relating to financing the purchase; and
the program is adapted to automatically activate the recording system in response to execution of the finance portion.

32. A recordkeeping system according to claim 31, wherein the recording system comprises a video camera.

33. A recordkeeping system according to claim 31, wherein the program is adapted to automatically deactivate the recording system in response to termination of the finance portion.

34. A recordkeeping system according to claim 33, wherein the program is configured to request and receive entry of a reason for deactivation prior to deactivating the recording system.

35. A recordkeeping system according to claim 31, further comprising a remote access system connected to the recording system and configured to remotely access the record.

36. A recordkeeping system according to claim 31, further comprising a computer connected to the recording system and containing a database, wherein the database is configured to associate a datum relating to the deal and an associated datum relating to the record.

37. A recordkeeping system according to claim 31, wherein the program comprises a dealer management program.

38. A computer-readable medium having a computer program stored thereon, wherein the computer program is configured to cause a computer to:
store information relating to a transaction;
initiate a finance portion of the program relating to financing the transaction; and
activate a recording system for making a record of the transaction in response to initiation of the finance portion.

39. A computer-readable medium according to claim 38, wherein the computer program is configured to cause the computer to store the record of the transaction at a location that the computer may access at a later time to replay the record.

40. A computer-readable medium according to claim 38, wherein the computer program is configured to cause the computer to automatically deactivate the recording system in response to termination of the finance portion.

41. A computer-readable medium according to claim 40, wherein the computer program is configured to cause the computer to require and receive entry of a reason from a user to deactivate the recording system prior to deactivating the recording system.

42. A computer-readable medium according to claim 38, wherein the computer program is configured to cause the computer to add information corresponding to the record to a searchable database of information.

43. A computer-readable medium according to claim 38, wherein the computer program is configured to cause the computer to facilitate remote access to replay the record.

44. A computer-implemented method for making records of a vehicle purchase, comprising:
receiving and storing non-finance information relating to the vehicle purchase;
receiving and storing finance information relating to the vehicle purchase;
automatically activating a recording system in response to receiving and storing the finance information; and
storing a recording generated by the recording system.

45. A computer-implemented method according to claim 44, wherein the recording system comprises a video camera.

46. A computer-implemented method according to claim 44, further comprising automatically deactivating the recording system in response to completion of the receiving and storing of the finance portion.

47. A computer-implemented method according to claim 46, further comprising automatically requesting and receiving entry of a reason for deactivation prior to deactivating the recording system.

48. A computer-implemented method according to claim 44, further comprising remotely accessing the recording.

49. A computer-implemented method according to claim 44, further comprising associating a datum relating to the deal and an associated datum relating to the recording.

50. A computer-implemented method according to claim 44, wherein the method is integrated into a dealer management software system.
